(19) United States
(12) Patent Application Publication
(10) Pub. No.: US 2026/0031458 A1
(43) Pub. Date: Jan. 29, 2026

(54) BATTERY CASE STRUCTURE

(71) Applicants: TOYODA GOSEI CO., LTD., Kiyosu-shi (JP); TOYOTA JIDOSHA KABUSHIKI KAISHA, Toyota-shi (JP)

(72) Inventors: Musashi SUZUKI, Kiyosu-shi (JP); Yuki TERAZAWA, Kiyosu-shi (JP); Nobuyoshi FUJIWARA, Nagoya-shi (JP)

(21) Appl. No.: 19/261,592

(22) Filed: Jul. 7, 2025

(30) Foreign Application Priority Data
Jul. 26, 2024 (JP) 2024-121449

(51) Int. Cl. H01M 50/242; B60K 1/04; H01M 50/249; H01M 50/262

(52) U.S. Cl. CPC H01M 50/242; B60K 1/04; H01M 50/249; H01M 50/262; B60K 2001/0438; H01M 2220/20

(57) ABSTRACT

Provided is a technique for more effectively reducing a force acting on a battery pack from a lower side. A battery case structure 1 mounted to a vehicle has a bottom support portion 3. In the bottom support portion 3, a top portion 4t of each of case support members 4 extends toward another one of the case support members 4. A buffer portion 5 is disposed between a lower surface of the top portion 4t and an upper surface of a road surface interference panel 8. In the buffer portion 5, an area of a buffer bottom surface 5b facing the road surface interference panel 8 is set to be larger than an area of a buffer top surface 5t facing the top portion 4t.

### TECHNICAL FIELD

The present disclosure relates to a battery case structure that is mounted to a vehicle.

### BACKGROUND ART

In recent years, one or more battery cells have been mounted to each of many vehicles. Examples of the battery cell include a secondary battery that is used as a battery for traveling and is repeatedly chargeable and dischargeable.

In recent years, particularly in a battery-type electric vehicle also called BEV, one or more battery cells stored in a battery case (referred to as battery pack as necessary in some cases in the present specification) have been mounted to a lower portion of the vehicle in general (see WO2013/073464). In a case where the battery pack is mounted to the lower portion of the vehicle, a distance from the battery pack to a driving device such as an electric motor becomes sufficiently short, and a sufficiently wide space is ensured in an engine room (or motor room) below a bonnet in a vehicle.

### SUMMARY OF INVENTION

### Technical Problem

The lower portion of a vehicle is near a road surface. Therefore, an external force such as vibration is likely to act on the battery pack mounted to the lower portion of the vehicle when, for example, the vehicle is traveling.

WO2013/073464 discloses a technique in which a battery pack having a plurality of battery cells stored in a battery case is suspended and fixed to a vehicle body frame, and the battery pack is thus stably mounted to the lower portion of the vehicle.

A battery case 24 disclosed in WO2013/073464 has a box-like shape in which a battery cover 39 and a battery tray 38 are combined, and a plurality of battery modules each including a plurality of battery cells thereinside are mounted in the battery case 24. In the battery case 24, the battery tray 38 supports the battery modules from the lower side and has a double-bottom structure formed of an upper plate 43 and a lower plate 44. A middle plate 45 is disposed between the upper plate 43 and the lower plate 44, and thus, a cooling air flow path is formed between the upper plate 43 and the lower plate 44.

In the battery case 24 having such a structure as disclosed in WO2013/073464, the battery tray 38 has the double-bottom structure, and positions of the upper plate 43 and the lower plate 44 are regulated by the middle plate 45. Therefore, in the battery case 24, a force that is derived from vibration or the like during traveling of the vehicle and that acts upward from below the battery pack is considered to be reduced by the battery tray 38 to some degree, so that a load acting on the battery pack is considered to be decreased to some degree.

However, for example, in a case where the vehicle runs over a curb, when the curb hits the battery case 24 upward from the lower side, an external force acts directly on the battery tray 38 of the battery case 24. In such a case, the battery tray 38 may be damaged, and the battery pack may thus be negatively affected.

Therefore, a technique for more effectively reducing a force acting on a battery pack from the lower side is required.

The present disclosure has been made in view of the aforementioned circumstances, and an object of the present disclosure is to provide a technique for more effectively reducing a force acting on a battery pack from the lower side, for solving the aforementioned problem.

### Solution to Problem

In order to solve the aforementioned problem, a battery case structure of the present disclosure is directed to a battery case structure that is mounted to a vehicle and that includes:
a battery case disposed above a road surface interference panel that is a part of a vehicle body, the battery case storing at least one battery cell; and
a bottom support portion disposed in a bottom space formed above the road surface interference panel and below the battery case, in which
the bottom support portion includes
a pair of case support members each of which is a rigid body, the pair of case support members being disposed below the battery cell on both lateral sides, respectively, of the battery cell, the pair of case support members each having a top portion facing the battery case, a bottom portion facing the road surface interference panel, and a wall portion connecting between the top portion and the bottom portion, and
a buffer portion having lower stiffness than each case support member, the buffer portion being disposed between the pair of case support members,
the top portion of each of the case support members extends toward another one of the case support members,
the buffer portion is disposed between a lower surface of the top portion and an upper surface of the road surface interference panel, and
an area of a buffer bottom surface facing the road surface interference panel is larger than an area of a buffer top surface facing the top portion in the buffer portion.

The battery case structure of the present disclosure allows a force acting on the battery pack from the lower side to be reduced.

### BRIEF DESCRIPTION OF DRAWINGS

FIG. 1 schematically illustrates a battery case structure of Example 1 as cut at a plane parallel to the up-down direction and the front-rear direction;

FIG. 2 is an enlarged view of a main portion in FIG. 1;

FIG. 3 schematically illustrates a reinforcing member in the battery case structure of Example 1;

FIG. 4 schematically illustrates a state where an adhesive material is fixed to the reinforcing member in the battery case structure of Example 1;

FIG. 5 illustrates a battery case structure of Example 2 as cut at the same position as in FIG. 2; and

FIG. 6 illustrates a battery case structure of Example 3 as cut at the same position as in FIG. 2.

### DESCRIPTION OF EMBODIMENTS

A battery case structure of the present disclosure is specifically described below.

Unless otherwise specified, a numerical value range “x to y” described herein includes, in the range, a lower limit x and an upper limit y. A numerical value range may be formed by discretionarily combining the upper limit value and the lower limit value, and numerical values described in the embodiment. Furthermore, numerical values discretionarily selected from the numerical value range may be used as the upper and lower limit values.

The battery case structure of the present disclosure is mounted to a vehicle, and a battery case in the battery case structure is disposed above a road surface interference panel that is a part of a vehicle body. That is, the battery case structure of the present disclosure is mounted to a lower portion of a vehicle, similarly to the structure described above in BACKGROUND ART.

The road surface interference panel is a part of a vehicle body. The road surface interference panel is disposed on a road surface side in the vehicle, and interferes with a road surface earlier than the battery case in a case where, for example, the vehicle runs over a curb. The road surface interference panel is connected to another vehicle body component such as a lower cross member, and a force exerted on the road surface interference panel from below the vehicle is transmitted to the entirety of the vehicle body and dispersed.

The battery case structure of the present disclosure includes a battery case and a bottom support portion.

The battery case stores at least one battery cell, and is disposed above the road surface interference panel described above. A space is formed above the road surface interference panel and below the battery case. The space is referred to as bottom space. The bottom support portion is disposed in the bottom space, and supports the battery case from the lower side in the bottom space.

In the battery case structure of the present disclosure, the bottom support portion includes a pair of case support members, and a buffer portion disposed between the pair of case support members.

The case support member is a rigid body, and the case support members are disposed below the battery cell stored in the battery case on both lateral sides, respectively, of the battery cell. Each case support member has a top portion facing the battery case, a bottom portion facing the road surface interference panel, and a wall portion connecting between the top portion and the bottom portion. The top portion of the case support member extends toward another case support member.

In the bottom support portion, the case support member is considered to be a member that is disposed between the road surface interference panel and the battery case and that supports the battery case from the lower side, on each of both the lateral sides of the battery cell. The case support member is a rigid body, and is disposed between the road surface interference panel and the battery case, and is thus considered to act to receive a force exerted on the road surface interference panel from below the vehicle earlier than the battery case in the battery case structure of the present disclosure.

The buffer portion is disposed in the bottom space between the pair of case support members, and is disposed between the lower surface of the top portion of each case support member and the upper surface of the road surface interference panel. Therefore, in the bottom support portion, the buffer portion receives a force exerted on the road surface interference panel from below the vehicle between the case support members disposed on both the lateral sides, respectively, of the battery cell, in other words, below the battery cell. That is, the buffer portion is considered to act to reduce a force acting on the battery cell from below the vehicle.

The buffer portion has lower stiffness than the case support member. Therefore, when the buffer portion receives a force exerted on the road surface interference panel from below the vehicle, the buffer portion is deformed or damaged earlier than the case support member. Since the buffer portion is deformed or damaged, a force acting on the battery pack from below the vehicle is reduced.

In the buffer portion, an area of a buffer bottom surface facing the road surface interference panel is larger than an area of the buffer top surface facing the top portion of the case support member. Therefore, the buffer portion receives a force exerted on the road surface interference panel from below the vehicle at a wide area, and effectively reduces the force acting from below the vehicle.

Through the above-described cooperation, the battery case structure of the present disclosure effectively reduces a force acting on the battery pack from the lower side.

In the battery case structure of the present disclosure, the area of the buffer top surface is less than the area of the buffer bottom surface in the buffer portion. Therefore, a region in which neither the buffer portion nor the case support member is disposed remains on the battery pack side in the bottom space. The region is referred to as gap region.

In the bottom space, the gap region on the battery pack side functions as a flow path for various cooling fluids typified by air or cooling water. The cooling fluid is allowed to flow through the gap region, so that the battery pack is cooled and maintained at a suitable temperature. That is, the battery case structure of the present disclosure is considered to have a function of cooling the battery pack in addition to the function of reducing a force acting on the battery pack from the lower side.

The battery case structure of the present disclosure is described below for each component thereof.

The battery case structure of the present disclosure includes the battery case and the bottom support portion, and further includes the road surface interference panel in some cases. The road surface interference panel is as described above. A material of the road surface interference panel is not particularly limited, but is particularly preferably a metal such as aluminum, iron, or stainless steel.

The battery case stores at least one battery cell. A material of the battery case is not particularly limited, but is, for example, selected from various materials such as resins and metals. Inside the battery case, an in-case support portion for supporting the battery cell from the outer side in the radial direction is preferably disposed. The in-case support portion is described below in detail.

In the battery case structure of the present disclosure, the battery cell stored in the battery case is formed by storing, in a battery container, battery components such as a positive electrode, a negative electrode, an electrolyte, terminals, and a separator, in general. The shape of the battery cell is determined depending on a shape of the battery container. The battery container is, for example, a metal can having a quadrangular tubular shape or a cylindrical shape in general. Examples of the other battery containers include a bag-shaped container formed of a laminate film as a material. A plurality of the battery cells electrically connected to each other are preferably stored in the form of an assembled battery in the battery case.

The battery case is mounted to a vehicle so as to be away upward from the road surface interference panel. Therefore, the bottom space is formed between the battery case and the road surface interference panel. The bottom support portion is disposed in the bottom space.

The bottom support portion includes a pair of the case support members and the buffer portion.

In the bottom support portion, the case support member is a rigid body, and acts to support the battery case from the lower side. Here, the rigid body means that stiffness of the case support member is higher than stiffness of the buffer portion. For example, the case support member preferably has higher flexural rigidity than the buffer portion. The flexural rigidity is calculated from a Young's modulus and a moment of inertia of area of a material used for each member. For example, as a material of the case support member, a material having higher stiffness than a material of the buffer portion is also preferably selected. As an index for stiffness of the material, a Young's modulus is adopted as described above.

The material of the case support member is properly selected as appropriate according to the expected stiffness. Examples of the material of the case support member include metals such as aluminum, iron, and stainless steel, thermoplastic resins such as polypropylene, polycarbonate, and acrylonitrile-styrene-butadiene copolymer resin (ABS), and thermosetting resins such as phenol resin and unsaturated polyester. A plurality of kinds of the materials may be used in combination. In a case where a resin material is selected as the material of the case support member, reinforcing fiber such as glass fiber and carbon fiber may be blended with the resin material. In this case, the resin material is so-called fiber reinforced plastic (FRP), and the stiffness and strength are enhanced by the reinforcing fiber.

The case support members are disposed below the battery cell on both lateral sides, respectively, of the battery cell in the above-described bottom space. The two case support members disposed on both the lateral sides, respectively, of one battery cell are referred to as a pair of case support members. In the bottom support portion, the number of the case support members is preferably commensurate with the number of the battery cells. That is, in a case where a plurality of the battery cells are stored in the battery case, a plurality of pairs of the case support members are preferably disposed so as to correspond to the number of the battery cells.

In the battery case structure of the present disclosure, in a case where the bottom support portion has a plurality of pairs of the case support members, some or all of the case support members may be integrated with each other.

In the battery case structure of the present disclosure, in a case where the battery case stores a plurality of battery cells, and the bottom support portion has a plurality of pairs of the case support members, the battery cells are preferably arranged in a predetermined direction, and the case support members are also preferably arranged along the direction in which the battery cells are arranged. Hereinafter, as necessary, the direction in which the battery cells or the case support members are arranged is referred to as arrangement direction in some cases.

The case support member has the top portion facing the battery case, the bottom portion facing the road surface interference panel, and the wall portion connecting between the top portion and the bottom portion.

The top portion extends toward another case support member in the pair of the case support members. The top portion is preferably plate-shaped. The top portion is in direct or indirect contact with the bottom portion of the battery case, or is not in contact with the bottom portion of the battery case.

The shape of the bottom portion is not particularly limited to a specific shape. However, the bottom portion is also preferably plate-shaped. The bottom portion is in direct or indirect contact with the road surface interference panel, or is not in contact with the road surface interference panel.

The shape of the case support member is properly designed as appropriate according to the stiffness required for the case support member. However, the case support member is often required to be light-weight since the case support member is a member mounted to a vehicle. In view of forming the light-weight case support member, the case support member is preferably hollow.

Specifically, preferable examples of the shape of the case support member include a hollow columnar shape, a tubular shape, a block-like shape having a U-shaped cross section (so-called U-shaped groove), and a block-like shape having an L-shaped cross-section.

The pair of the case support members have the same shape or different shapes. In a case where the bottom support portion has a plurality of pairs of the case support members, the case support members have the same shape or different shapes. All the case support members particularly preferably have the same shape in order to reduce production cost of the battery case structure of the present disclosure.

The case support member may be merely inserted between the battery case and the road surface interference panel. However, the case support member is preferably fixed to at least one of the battery case and the road surface interference panel for convenience of mounting to a vehicle.

As described above, the case support member acts to receive a force exerted on the road surface interference panel from below a vehicle earlier than the battery case in the battery case structure of the present disclosure. Therefore, the case support member is preferably fixed to at least the road surface interference panel in order to efficiently receive a force exerted on the road surface interference panel from below the vehicle.

A method for fixing the case support member to the battery case or the road surface interference panel is not particularly limited, and various methods such as adhesion, welding, or fastening and fixing by a bolt, a clip, or the like, are adopted.

In a case where, for example, a vehicle runs over a curb, a high external force acts on the case support member from the road surface interference panel side. Therefore, the bottom portion of the case support member and the road surface interference panel are preferably firmly fixed to each other, and are particularly preferably fastened by a bolt.

The wall portion connects between the top portion and the bottom portion, and extends in almost the up-down direction between the top portion disposed on the upper side and the bottom portion disposed at the lower side. The shape of the wall portion is not particularly limited. However, the wall portion preferably extends along the up-down direction, that is, the vertical direction in order to allow the case support member to efficiently receive a force exerted on the road surface interference panel from below the vehicle. Specifically, an intersection angle (minor angle) of the wall portion with respect to the vertical direction is preferably 45° or less and more preferably 30° or less, 20° or less, 10° or less, or 5° or less.

In a case where at least a part of the wall portion is not linear, the intersection angle of the wall portion with respect to the vertical direction as described above means an intersection angle of a plane tangent to the wall portion with respect to the vertical direction.

The case support member is disposed over the entirety of the bottom space in the height direction, that is, in the up-down direction, or is disposed merely in a part of the bottom space in the height direction.

In a case where the case support member is disposed merely in a part of the bottom space in the height direction, the bottom portion of the case support member is preferably in direct or indirect contact with the road surface interference panel.

The case support member is disposed merely in a part of the bottom space in a depth direction, that is, in the direction orthogonal to the up-down direction and the arrangement direction, or is continuously disposed over the entirety of the bottom space in the depth direction.

For example, in a case where the battery cells are arranged in the depth direction in addition to the arrangement direction, one case support member is disposed for one battery cell, or one case support member is disposed for a plurality of the battery cells. That is, one case support member may continuously extend in the depth direction on the lateral sides of the plurality of the battery cells arranged in the depth direction.

In a case where the battery case has the above-described in-case support portion, the case support member and the in-case support portion are preferably arranged in the up-down direction. In this case, an upward force received by the case support member is transmitted to the in-case support portion, and a force acting on the battery cell and the battery case in the battery pack is thus reduced, so that a force acting on the battery pack from the lower side is more effectively reduced.

The shape of the in-case support portion is not particularly limited, and preferable examples of the shape of the in-case support portion include shapes similar to the shapes of the case support portion as described above.

The buffer portion is disposed between a pair of the case support members. The buffer portion has lower stiffness than the case support member, and at least one selected from elastic materials such as rubber and elastomer and various resin materials is preferably used. Such a material is a porous material having pores thereinside, or a non-porous material having no pores.

Specific examples of the elastic material to be selected as a material of the buffer portion include various kinds of rubbers such as urethane rubber, fluororubber, chloroprene rubber, butyl rubber, nitrile rubber, and ethylene propylene rubber, and elastomers. Specific examples of the resin material include thermoplastic resins such as polypropylene, polyethylene, polystyrene, polycarbonate, and thermoplastic polyurethane, and thermosetting resins such as unsaturated polyester, silicone resin, and thermosetting polyurethane.

The resin material as the material of the buffer portion is a hard or soft resin material. However, in a case where the bottom support portion includes a reinforcing member described below, a soft resin is preferably selected. In a case where the bottom support portion does not include the reinforcing member, a hard resin is preferably selected. In a case where the bottom support portion includes the reinforcing member, an elastic material is particularly preferably selected as a material of the buffer portion. The reinforcing member is described below in detail.

For reference, the hard resin described herein refers to a resin in which the flexural modulus is 2000 kg/cm² or more in a steady state. The soft resin described herein refers to a resin in which the flexural modulus is 700 kg/cm² or less in a steady state.

The buffer portion is disposed in the bottom space between a pair of the case support members, and is disposed between the lower surface of the top portion of each case support member and the upper surface of the road surface interference panel. Therefore, the buffer top surface that is the upper surface of the buffer portion opposes the lower surface of the top portion of the case support member, and the buffer bottom surface that is the lower surface of the buffer portion opposes the upper surface of the road surface interference panel.

As described above, the buffer portion is disposed between the lower surface of the top portion of the case support member and the upper surface of the road surface interference panel. Therefore, in a normal state in which a force is not exerted on the road surface interference panel form below the vehicle, the lower surface of the top portion and the buffer top surface are distant from each other or in contact with each other. The buffer bottom surface and the upper surface of the road surface interference panel are distant from each other or in contact with each other.

In a case where a force is exerted on the road surface interference panel from below the vehicle, the buffer portion needs to come into contact with the road surface interference panel at a large area in order to effectively reduce the force.

Meanwhile, in the normal state, the gap region of the bottom space, that is, a region of the bottom space on the battery pack side, needs to function as a flow path for various cooling fluids typified by air and cooling water in order to effectively cool the battery cell.

In the buffer portion of the battery case structure of the present disclosure, an area of the buffer bottom surface is larger than the area of the buffer top surface. The buffer portion having such a structure comes into contact with the road surface interference panel at a large area at the road surface interference panel side portion, and a large gap region is formed in the battery case side portion.

Since the gap region of the bottom space is used as a flow path for a cooling fluid, a flow path having a large cross-sectional area in the gap region is advantageous in view of pressure loss. Therefore, the number of the gap regions between a pair of the case support members is preferably small, and the number of the gap regions is particularly preferably one. The gap region having such a structure is preferably disposed at almost the center portion between the pair of the case support members.

The buffer top surface of the buffer portion opposes each of the two top portions of a pair of the case support members. Therefore, the buffer portion has two buffer top surfaces, or one buffer top surface obtained by connecting the two buffer top surfaces with each other.

In a case where the buffer portion has two buffer top surfaces, the buffer top surface facing the top portion of a first support member that is one of a pair of the case support members is referred to as first buffer top surface. Meanwhile, the buffer top surface facing the top portion of a second support member that is the other of the pair of the case support members is referred to as second buffer top surface.

In this case, the buffer portion preferably has an almost symmetrical shape in the arrangement direction connecting the pair of the case support members to each other.

The gap region is preferably formed so as to be large at a position between the first buffer top surface and the second buffer top surface, and become gradually smaller toward the first buffer top surface and the second buffer top surface. In other words, in the bottom space, the gap region preferably becomes gradually smaller from a mid-position between the first buffer top surface and the second buffer top surface toward the first and the second buffer top surfaces.

The buffer portion having such a structure preferably has an almost symmetrical shape in the arrangement direction, in other words, in the first buffer top surface—second buffer top surface direction. The buffer portion is divided into a first buffer top surface side portion and a second buffer top surface side portion, or the buffer portion is an integral member.

In a case where the buffer portion is divided into the first buffer top surface side portion and the second buffer top surface side portion, the cross-sectional shape obtained by cutting each of the first and the second buffer top surface side portions at a plane extending in the arrangement direction and the up-down direction is considered to be preferably an almost triangular shape or an almost trapezoidal shape.

Preferably, the bottom support portion further has a reinforcing member in addition to a pair of the case support members and the buffer portion corresponding to the case support members as described above. The reinforcing member is disposed on the upper side of the buffer portion, and acts to interfere with the upward deformation trajectory of the road surface interference panel, from the upper side, in the bottom space, and inhibit a region between the pair of the case support members from being crushed and deformed in the up-down direction. Since the buffer portion and the reinforcing member are disposed between the pair of the case support members, a force acting from the lower side between the pair of the case support members is more effectively reduced.

The reinforcing member is preferably formed of an elastic material and has higher strength than the buffer portion.

Here, the elastic material refers to an elastically deformable material. Although the material is not particularly limited, at least one selected from metals such as spring steel, aluminum, and iron, thermoplastic resins such as polypropylene, polyethylene, polystyrene, and thermoplastic polyurethane, and thermosetting resins such as unsaturated polyester, silicone resin, and thermosetting polyurethane, is preferably used.

Here, strength higher than that of the buffer portion means that the flexural modulus is higher than that of the buffer portion, and the flexural modulus of the reinforcing member is particularly preferably 7000 kg/cm² or more, 7500 kg/cm² or more, or 8000 kg/cm² or more in a steady state.

Preferably, the reinforcing member extends over and between the first buffer top surface and the second buffer top surface of the buffer portion, and is disposed between the case support member and the buffer portion. More specifically, the end portion of the reinforcing member on the case support member side is preferably inserted between the top portion of the case support member and the first buffer top surface of the buffer portion or between the top portion of the case support member and the second buffer top surface of the buffer portion.

Hereinafter, as necessary, a portion that is the end portion of the reinforcing member and is inserted between the top portion of the case support member and the first buffer top surface of the buffer portion, and a portion that is the end portion of the reinforcing member and is inserted between the top portion of the case support member and the second buffer top surface of the buffer portion are each referred to as held end portion.

In view of more effectively reducing a force acting from the lower side between the pair of the case support members, preferably, the reinforcing member further has an arch-like shape recessed toward the road surface interference panel, at a position between the first buffer top surface and the second buffer top surface of the buffer portion. Hereinafter, as necessary, the arch-shaped portion of the reinforcing member as recessed toward the road surface interference panel is referred to as arched bottom portion in some cases.

In view of more effectively reducing a force acting from the lower side between the pair of the case support members, the arched bottom portion of the reinforcing member is more preferably in contact with the road surface interference panel.

The reinforcing member having such a structure preferably has an almost symmetrical shape in the arrangement direction, that is, in the first buffer top surface—second buffer top surface direction. The reinforcing member is divided into a first buffer top surface side portion and a second buffer top surface side portion, or the reinforcing member is an integral member.

The buffer portion and the reinforcing member are integrated with each other, or are separate from each other. However, the buffer portion and the reinforcing member are preferably integrated with each other in order to maintain relative positions between the buffer portion and the reinforcing member also when a force acts from the lower side.

A method for integrating the buffer portion and the reinforcing member with each other is not particularly limited, and a method such as adhesion, welding, or fastening and fixing is adopted.

The buffer portion and the reinforcing member are preferably adhered to each other by an adhesive material in order to easily integrate the buffer portion and the reinforcing member with each other at low cost.

As the adhesive material, an adhesive agent is selected, or an adhesive member in which an adhesive agent is applied to both surfaces of a base sheet as in a double-sided tape, is selected.

The adhesive material is preferably formed of a plurality of adhesive members in order to more easily integrate the buffer portion and the reinforcing member with each other at low cost.

In a case where the adhesive material is formed of a plurality of adhesive members, the plurality of adhesive members are arranged between the buffer portion and the reinforcing member. In such a case, the plurality of adhesive members are preferably prevented from being excessively long.

A force acts on the buffer portion and the reinforcing member in such a direction as to change the relative positions between the buffer portion and the reinforcing member due to vibration or the like during traveling of the vehicle. Thus, a force in the separating direction acts on the adhesive member.

In a case where a part of the adhesive members separate from the buffer portion or the reinforcing member, the separated portion is gradually increased, and the integration between the buffer portion and the reinforcing member by the adhesive members is no longer maintained in some cases.

In a case where a long adhesive member is used, an area in which the buffer portion and the reinforcing member are adhered to each other is large for each adhesive member, damage becomes very large when each adhesive member is separated, and preferable integration between the buffer portion and the reinforcing member as a whole may be difficult to maintain.

As described above, the reinforcing member extends over and between the first buffer top surface and the second buffer top surface of the buffer portion, and further has an arch-like shape recessed toward the road surface interference panel at a position between the first buffer top surface and the second buffer top surface. In the reinforcing member having such a structure, the length in the arrangement direction connecting the first buffer top surface and the second buffer top surface to each other is relatively large. Therefore, in a case where the adhesive members are formed so as to extend in the direction intersecting the arrangement direction, and are arranged along the arrangement direction, the length of each adhesive member is made relatively small. Thus, a malfunction in which damage becomes very large in the case of each adhesive member being separated as described above is inhibited.

The reinforcing member extends over and between the first buffer top surface and the second buffer top surface of the buffer portion, and further has an arch-like shape recessed toward the road surface interference panel at a position between the first buffer top surface and the second buffer top surface as described above. In the reinforcing member having such a structure, the longitudinal direction is considered to be a curving direction. Therefore, the arrangement direction in which the adhesive members are arranged is not intended to strictly coincide with the direction connecting the first buffer top surface and the second buffer top surface of the buffer portion to each other, and may be a direction along the reinforcing member curving direction substantially along the arrangement direction.

In a case where a force from the lower side acts on the battery case structure of the present disclosure, the reinforcing member is preferably deformed such that the arched bottom portion is oriented upward in order to effectively reduce the force. The reinforcing member preferably has a structure for guiding a direction in which such an arched bottom portion is deformed.

Specifically, the reinforcing member is preferably recessed downward at least at one of a position between the held end portion on the first buffer top surface side and the arched bottom portion, and a position between the held end portion on the second buffer top surface side and the arched bottom portion. Alternatively, the reinforcing member is preferably recessed downward at least at one of a position between the arched bottom portion and the first buffer top surface and a position between the arched bottom portion and the second buffer top surface.

The downward recessed portion of the reinforcing portion is referred to as reinforcing member inflection point.

The reinforcing portion having the reinforcing member inflection point is bent around the reinforcing member inflection point, and is deformed so as to orient the arched bottom portion upward in a case where a force from the lower side acts on the battery case structure of the present disclosure.

In this case, the buffer portion preferably has a recessed shape on a surface facing the reinforcing member inflection point. The portion having the recessed shape in the buffer portion is referred to as buffer portion inflection point. In a case where the reinforcing portion having the reinforcing member inflection point is bent around the reinforcing member inflection point and deformed so as to orient the arched bottom portion upward, the buffer portion having the buffer portion inflection point is deformed so as to follow the deformation of the reinforcing portion.

The battery case structure of the present disclosure is described below by way of specific examples.

### Example 1

A battery case structure of Example 1 includes a lithium ion secondary battery that is mounted to a vehicle as a battery cell. The battery cell functions as a battery for traveling of a vehicle.

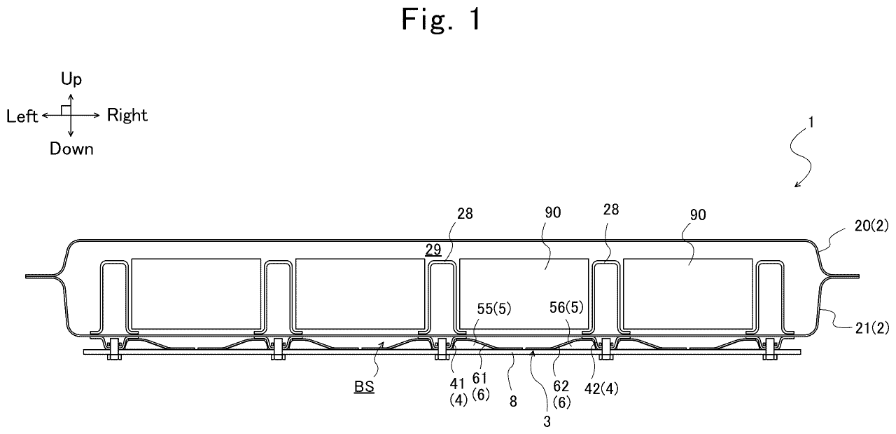

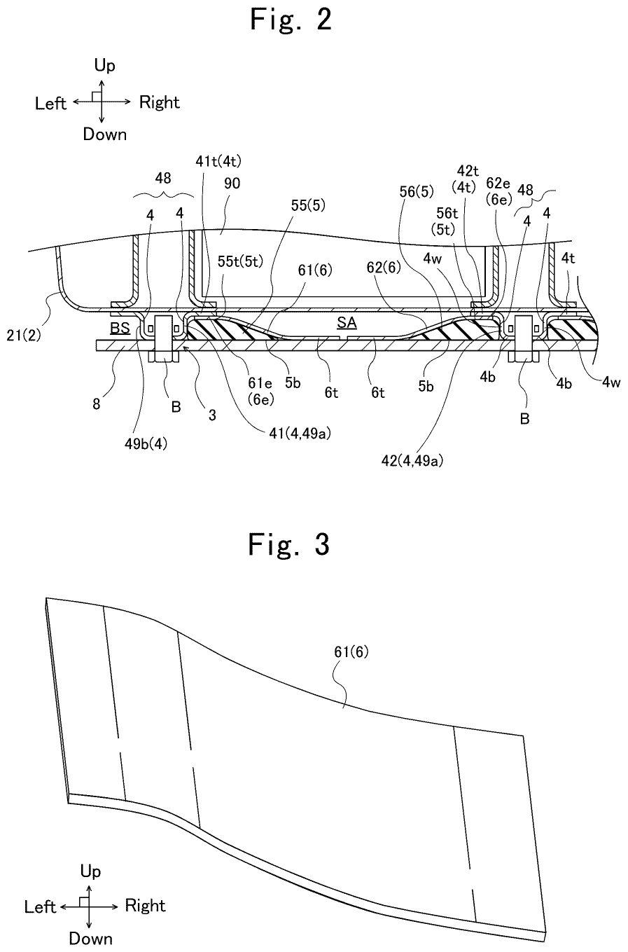

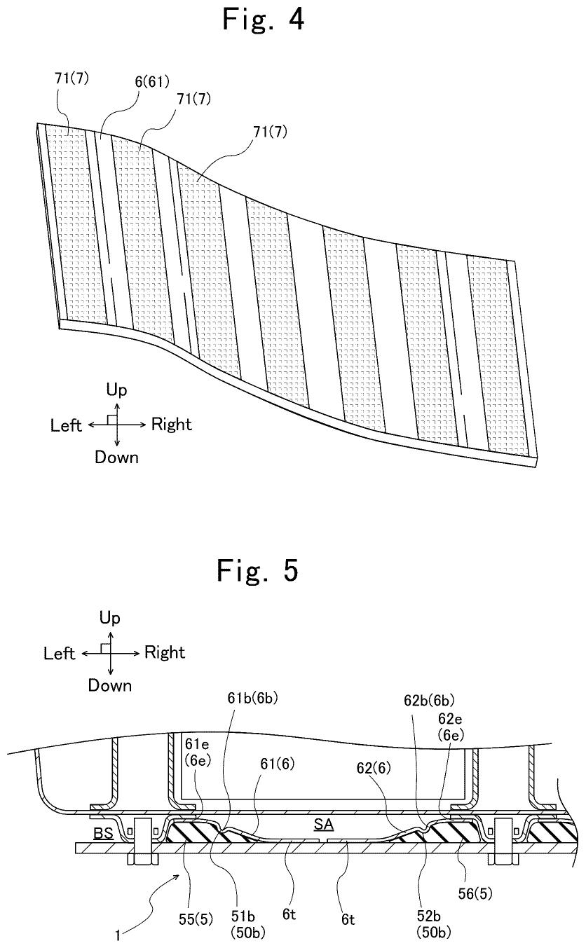

FIG. 1 schematically illustrates the battery case structure of Example 1 as cut at a plane parallel to the up-down direction and the front-rear direction. FIG. 2 is an enlarged view of a main portion in FIG. 1. FIG. 3 schematically illustrates a reinforcing member in the battery case structure of Example 1. FIG. 4 schematically illustrates a state where an adhesive material is fixed to the reinforcing member in the battery case structure of Example 1.

As illustrated in FIG. 1, a battery case structure 1 of Example 1 includes a battery case 2, a bottom support portion 3, and a road surface interference panel 8.

The road surface interference panel 8 is formed of aluminum, and is almost plate-shaped. The road surface interference panel 8 is a part of a vehicle body and is a member called undercover.

The road surface interference panel 8 is fastened and fixed to a not-illustrated lower cross member that is another part of the vehicle body by not-illustrated bolts, and is thus connected to the lower cross member.

The road surface interference panel 8 is disposed further below a floor panel (not illustrated) of a vehicle, and is exposed to the outside on the lower side of the vehicle.

The battery case 2 is formed of iron, and has an almost box-like shape in which an upper case 20 and a lower case 21 are combined with each other. The upper case 20 is opened downward, and the lower case 21 is opened upward. In the battery case 2, a storage space 29 is formed and partitioned. In the storage space 29, a plurality of battery cells 90 are stored in the form of an assembled battery. The plurality of battery cells 90 are arranged along the left-right direction in the figure, in other words, along the vehicle width direction. In the battery case structure 1 of Example 1, the above-described arrangement direction is the left-right direction.

The battery cells 90 are further arranged in the front-rear direction, that is, in the front side—depth side direction on the surface of the drawing sheet in FIG. 1 and FIG. 2, although not shown.

As illustrated in FIG. 1 and FIG. 2, an in-case support portion 28 for supporting the battery cell 90 from the outside in the radial direction is disposed in the battery case 2. The in-case support portion 28 is disposed between the battery cells 90 adjacent to each other in the left-right direction, and the in-case support portions 28 are arranged in the left-right direction similarly to the battery cells 90.

The in-case support portion 28 is formed of the same iron as the battery case 2, and has an almost inverted-U-like shape so as to orient the curved portion upward. The lower end portion of the in-case support portion 28 is welded to the lower case 21.

As illustrated in FIG. 2, the battery case 2 is mounted to a vehicle in a state where the lower case 21 is oriented downward and is away upward from the road surface interference panel 8. The bottom support portion 3 is disposed in a bottom space BS formed between the battery case 2 and the road surface interference panel 8.

The bottom support portion 3 includes four pairs of case support members 4, four buffer portions 5, four reinforcing members 6, and an adhesive material 7 illustrated in FIG. 4.

Each of the case support members 4 is a rigid body formed of iron, and the case support members 4 are disposed below the corresponding battery cell 90 on both lateral sides, respectively, of the battery cell 90 in the bottom space BS as illustrated in FIG. 2.

Each case support member 4 has an almost L-like shape that includes a top portion 4t facing the battery case 2, a bottom portion 4b facing the road surface interference panel 8, and a wall portion 4w connecting between the top portion 4t and the bottom portion 4b. Hereinafter, as necessary, a pair of the case support members 4 is referred to as case support member pair 49.

As illustrated in FIG. 2, the two case support members 4 adjacent to each other are integrally formed to form an almost inverted-U-shaped case support portion 48. The two case support members 4 forming the same case support portion 48 belong to different case support member pairs 49 (49a, 49b illustrated in FIG. 2), respectively, adjacent to each other.

Each case support portion 48 extends also in the depth direction, that is, in the front-rear direction. More specifically, the direction in which the case support portion 48 extends is the depth direction on the surface of the drawing sheet in FIG. 1 and FIG. 2.

As described above, the battery cells 90 are further arranged in the front-rear direction, and each case support portion 48 is considered to continuously extend in the front-rear direction, on the lateral sides of the plurality of battery cells 90 arranged in the front-rear direction, between the battery cells 90 adjacent to each other in the left-right direction.

The top portion 4t of each case support member 4 has a plate-like shape extending in the left-right direction and the front-rear direction, and is in surface contact with the lower surface of the bottom portion of the battery case 2.

The bottom portion 4b of each case support member 4 also has a plate-like shape extending in the left-right direction and the front-rear direction. The two case support members 4 belonging to the same case support portion 48 are integrated with each other at the bottom portions 4b. The bottom portion 4b is in surface contact with the road surface interference panel 8.

The two case support members 4 belonging to the same case support member pair 49 have almost the same shapes which are symmetrical in the left-right direction. The two case support members 4 belonging to the same case support portion 48 also have almost the same shapes which are symmetrical in the left-right direction. The case support portions 48 have almost the same shape.

The bottom portion 4b of the case support member 4 is fastened and fixed to the road surface interference panel 8 by a bolt B. The end portion of the bolt B is oriented upward. The end portion of the bolt B is disposed in the case support portion 48 having an almost inverted-U-like shape, and positioned below the battery case 2.

The wall portion 4w of the case support member 4 has a plate-like shape extending in the front-rear direction and in almost the up-down direction, and connects between the top portion 4t and the bottom portion 4b. In the battery case structure 1 of Example 1, an intersection angle (minor angle) of the wall portion 4w with respect to the vertical direction is 5° or less, and is almost 0°.

As described above, in the case support member 4, the top portion 4t is in contact with the battery case 2, and the bottom portion 4b is in contact with the road surface interference panel 8. Therefore, the case support member 4 is disposed over the entirety of the bottom space BS in the up-down direction.

The case support portion 48 and the in-case support portion 28 are arranged in the up-down direction.

One of the case support members 4 belonging to the same case support member pair 49 is referred to as first support member 41, and the other of the case support members 4 belonging to the same case support member pair 49 is referred to as second support member 42. The first support member 41 is disposed to the left of the battery cell and the second support member 42 is disposed to the right of the battery cell.

The buffer portion 5 is disposed between the first support member 41 and the second support member 42. In the battery case structure 1 of Example 1, the buffer portion 5 is an elastic body formed of urethane rubber.

The buffer portion 5 is disposed between the lower surfaces of the top portion 4t of the first support member 41 and the top portion 4t of the second support member 42, and the upper surface of the road surface interference panel 8. A buffer top surface 5t that is the upper surface of the buffer portion 5 opposes the lower surface of the top portion 4t, and a buffer bottom surface 5b that is the lower surface of the buffer portion 5 opposes the upper surface of the road surface interference panel 8. The buffer bottom surface 5b is in surface contact with the upper surface of the road surface interference panel 8.

The buffer portion 5 is divided into two portions that are a left-side portion and a right-side portion. The left-side portion is referred to as first buffer divided body 55, and the right-side portion is referred to as second buffer divided body 56. The first buffer divided body 55 and the second buffer divided body 56 have almost the same shapes that are symmetrical in the left-right direction.

In the first buffer divided body 55 and the second buffer divided body 56, an area of the buffer bottom surface 5b is larger than an area of the buffer top surface 5t. A large gap region SA is formed at almost the center portion between the first buffer divided body 55 and the second buffer divided body 56. The gap region SA is disposed above the first buffer divided body 55 and the second buffer divided body 56, that is, on the battery case 2 side in the bottom space BS.

A first buffer top surface 55t that is the buffer top surface 5t of the first buffer divided body 55 opposes a first support top portion 41t that is the top portion 4t of the first support member 41. A second buffer top surface 56t that is the buffer top surface 5t of the second buffer divided body 56 opposes a second support top portion 42t that is the top portion 4t of the second support member 42.

The cross-sectional shape obtained by cutting the first buffer divided body 55 at a plane extending in the left-right direction and the up-down direction is almost trapezoidal. Similarly, the cross-sectional shape obtained by cutting the second buffer divided body 56 at a plane extending in the left-right direction and the up-down direction is almost trapezoidal.

The reinforcing member 6 is disposed on the upper side of the buffer portion 5 and on the lower side of the case support member 4.

The material of the reinforcing member 6 is spring steel, and the reinforcing member 6 has higher strength than the buffer portion 5. The reinforcing member 6 has a flexural modulus of about 7000 kg/cm² in a steady state.

The reinforcing member 6 extends over and between the first buffer top surface 55t and the second buffer top surface 56t of the buffer portion 5. A held end portion 6e that is the end portion of the reinforcing member 6 is disposed between the case support member 4 and the buffer portion 5. The reinforcing member 6 has an arch-like shape recessed toward the road surface interference panel 8 at a position between the first buffer top surface 55t and the second buffer top surface 56t of the buffer portion 5. An arched bottom portion 6t of the reinforcing member 6 is in surface contact with the road surface interference panel 8.

In the battery case structure 1 of Example 1, the reinforcing member 6 is divided into two portions that are a left-side portion and a right-side portion. The left-side portion is referred to as first reinforcing divided body 61, and the right-side portion is referred to as second reinforcing divided body 62. The first reinforcing divided body 61 and the second reinforcing divided body 62 have almost the same shapes that are symmetrical in the left-right direction.

The end portion of the first reinforcing divided body 61 on the first support member 41 side is inserted between the first support top portion 41t and the first buffer top surface 55t. The end portion of the second reinforcing divided body 62 on the second support member 42 side is inserted between the second support top portion 42t and the second buffer top surface 56t.

The buffer portion 5 and the reinforcing member 6 are adhered to and integrated with each other by the adhesive material 7. The adhesive material 7 includes a plurality of adhesive members 71, and the adhesive member 71 is implemented by a double-sided tape as illustrated in FIG. 4.

Each adhesive member 71 has an almost elongated rectangular shape. Each adhesive member 71 is firstly adhered to the reinforcing member 6, and both the adhesive member 71 and the reinforcing member 6 are thereafter adhered to the buffer portion 5.

As illustrated in FIG. 3, the first reinforcing divided body 61 of the reinforcing member 6 has an almost rectangular curved-plate-like shape in which the longitudinal direction is the left-right direction. The second reinforcing divided body 62 of the reinforcing member 6 has almost the same shape, although not illustrated.

As illustrated in FIG. 4, the adhesive members 71 extend in the front-rear direction orthogonal to the left-right direction, and are arranged along the left-right direction.

When a force is exerted from the lower side on a vehicle to which the battery case structure 1 of Example 1 is mounted, the road surface interference panel 8 firstly receives the force. A part of the force exerted on the road surface interference panel 8 is transmitted to the entirety of the vehicle body and dispersed.

The case support member 4 in contact with the road surface interference panel 8 on the upper side of the road surface interference panel 8 receives another part of the force exerted on the road surface interference panel 8 from below the vehicle at a portion lateral to the battery cell 90.

In the battery case structure 1 of Example 1, the reinforcing member 6 is disposed between a pair of the case support members 4. The reinforcing member 6 is a rigid body and is disposed on the upper side of the road surface interference panel 8, and thus supports the road surface interference panel 8 deformed upward when receiving an external force from the lower side, from the upper side, below the battery cell 90. The reinforcing member 6 is an elastic body, and is elastically deformed by being pressed upward by the road surface interference panel 8 deformed upward and reduces a force acting upward through the road surface interference panel 8.

The buffer portion 5 disposed on the lower side of the reinforcing portion and on the upper side of the road surface interference panel 8 receives, below the battery cell 90, a force exerted on the road surface interference panel 8 from below the vehicle. At this time, the buffer portion 5 is elastically deformed and reduces the force.

Through the above-described cooperation, the battery case structure 1 of Example 1 allows a force acting on the battery pack from the lower side to be effectively reduced.

### Example 2

A battery case structure 1 of Example 2 is almost the same as the battery case structure 1 of Example 1 except for shapes of the reinforcing member 6 and the buffer portion 5.

FIG. 5 illustrates the battery case structure 1 of Example 2 as cut at the same position as in FIG. 2.

The battery case structure 1 of Example 2 is described below by mainly focusing on differences from the battery case structure 1 of Example 1.

In the battery case structure 1 of Example 2, the reinforcing member 6 has two reinforcing member inflection points 6b, specifically, a first reinforcing member inflection point 61b and a second reinforcing member inflection point 62b.

Specifically, in the battery case structure 1 of Example 2, the reinforcing member 6 is formed of the first reinforcing divided body 61 and the second reinforcing divided body 62, similarly to the reinforcing member 6 in the battery case structure 1 of Example 1.

The first reinforcing divided body 61 is curved so as to be recessed downward at a position between the arched bottom portion 6t and the held end portion 6e. The recessed portion is the first reinforcing member inflection point 61b. The second reinforcing divided body 62 is curved so as to be recessed downward at a position between the arched bottom portion 6t and the held end portion 6e. The recessed portion is the second reinforcing member inflection point 62b.

In the battery case structure 1 of Example 2, the buffer portion 5 has two buffer portion inflection points 50b, specifically, a first buffer portion inflection point 51b and a second buffer portion inflection point 52b.

In the battery case structure 1 of Example 2, the buffer portion 5 is formed of the first buffer divided body 55 and the second buffer divided body 56, similarly to the buffer portion 5 in the battery case structure 1 of Example 1.

In the first buffer divided body 55, the surface facing the first reinforcing member inflection point 61b is recessed along the first reinforcing member inflection point 61b. The recessed portion is the first buffer portion inflection point 51b. Similarly, in the second buffer divided body 56, the surface facing the second reinforcing member inflection point 62b is recessed along the second reinforcing member inflection point 62b. The recessed portion is the second buffer portion inflection point 52b.

When a force from the lower side acts on the battery case structure 1 of Example 2, a force from the lower side acts also on the arched bottom portion 6t of the reinforcing member 6. At this time, the reinforcing member 6 is bent around the first reinforcing member inflection point 61b and the second reinforcing member inflection point 62b, and deformed so as to orient the arched bottom portion 6t upward. The first reinforcing member inflection point 61b and the second reinforcing member inflection point 62b having such structures are considered to be a structure for guiding a direction in which the arched bottom portion 6t in the reinforcing member 6 is deformed.

At this time, the buffer portion 5 follows the reinforcing member 6, and is bent and deformed around the first buffer portion inflection point 51b and the second buffer portion inflection point 52b.

In the battery case structure 1 of Example 2, the reinforcing member 6 is bent around the first reinforcing member inflection point 61b and the second reinforcing member inflection point 62b, and is thus deformed so as to orient the arched bottom portion 6t upward. Therefore, when the reinforcing member 6 is deformed, the arched bottom portion 6t is inhibited from interfering with the road surface interference panel 8, the case support portion 48, or the like, and a force acting on the battery case structure 1 from the lower side is effectively reduced.

Thus, the battery case structure 1 of Example 2 allows a force acting on the battery pack from the lower side to be more effectively reduced.

### Example 3

A battery case structure 1 of Example 3 is almost the same as the battery case structure 1 of Example 1 except that the reinforcing member 6 is not provided and the buffer portion 5 is formed of a hard resin.

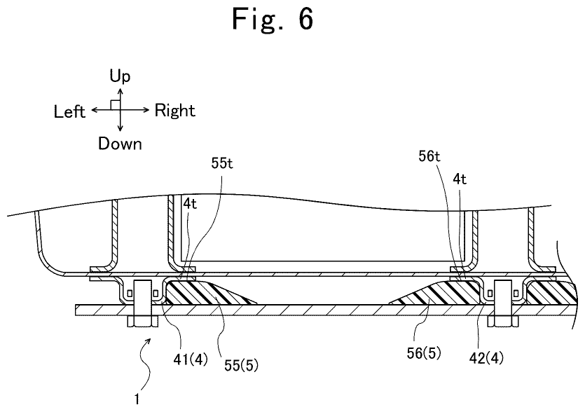

FIG. 6 illustrates the battery case structure 1 of Example 3 as cut at the same position as in FIG. 2.

The battery case structure 1 of Example 3 is described below by mainly focusing on differences from the battery case structure 1 of Example 1.

In the battery case structure 1 of Example 3, the reinforcing member 6 is not provided, the first buffer top surface 55t of the first buffer divided body 55 is in direct contact with the top portion 4t of the first support member 41, and the second buffer top surface 56t of the second buffer divided body 56 is in direct contact with the top portion 4t of the second support member 42.

The first buffer divided body 55 and the second buffer divided body 56 are formed of polycarbonate that is a hard resin.

In the battery case structure 1 of Example 3, the reinforcing member 6 is not provided, and a hard resin is selected instead as a material of the buffer portion 5. Therefore, in the battery case structure 1 of Example 3, the buffer portion 5 has functions of both the reinforcing member 6 and the buffer portion 5 of the battery case structure 1 of Example 1. Therefore, also in the battery case structure 1 of Example 3, a force acting from the lower side between the pair of the case support members 4 is effectively reduced.

Although the present disclosure has been described above, the present disclosure is not limited to the above-described embodiment and the like, the components described in the embodiment and the like may be extracted and combined as appropriate, and various modifications may be made without departing from the gist of the present disclosure.

In addition, the specification of the present disclosure discloses not only the technical concept according to the citation relationship of the claims as originally filed, but also the technical concept obtained by combining the matters recited in the claims as appropriate.

1. A battery case structure that is mounted to a vehicle, the battery case structure comprising:
a battery case disposed above a road surface interference panel that is a part of a vehicle body, the battery case storing at least one battery cell; and
a bottom support portion disposed in a bottom space formed above the road surface interference panel and below the battery case, wherein
the bottom support portion includes
a pair of case support members each of which is a rigid body, the pair of case support members being disposed below the battery cell on both lateral sides, respectively, of the battery cell, the pair of case support members each having a top portion facing the battery case, a bottom portion facing the road surface interference panel, and a wall portion connecting between the top portion and the bottom portion, and
a buffer portion having lower stiffness than each case support member, the buffer portion being disposed between the pair of case support members,
the top portion of each of the case support members extends toward another one of the case support members,
the buffer portion is disposed between a lower surface of the top portion and an upper surface of the road surface interference panel, and
an area of a buffer bottom surface facing the road surface interference panel is larger than an area of a buffer top surface facing the top portion in the buffer portion.

2. The battery case structure according to claim 1, wherein
the buffer portion has a first buffer top surface facing the top portion of a first support member that is one of the pair of case support members, and a second buffer top surface facing the top portion of a second support member that is another one of the pair of case support members, and
a gap region in which the bottom support portion is not disposed is large at a position between the first buffer top surface and the second buffer top surface, and becomes gradually smaller toward the first buffer top surface and the second buffer top surface, in the bottom space.

3. The battery case structure according to claim 1, wherein the buffer portion is formed of an elastic material or a hard resin.

4. The battery case structure according to claim 2, wherein
the bottom support portion has a reinforcing member disposed on an upper side of the buffer portion, and
the reinforcing member is formed of an elastic material and has higher strength than the buffer portion, extends over and between the first buffer top surface and the second buffer top surface, is disposed between the case support members and the buffer portion, and has an arch-like shape recessed toward the road surface interference panel at a position between the first buffer top surface and the second buffer top surface.

5. The battery case structure according to claim 4, wherein, in the reinforcing member, a reinforcing member inflection point recessed downward is disposed on at least one of: a position between a held end portion disposed between the case support member and the first buffer top surface, and an arched bottom portion recessed in an arch-like shape toward the road surface interference panel; and a position between a held end portion disposed between the case support member and the second buffer top surface, and the arched bottom portion.

6. The battery case structure according to claim 5, wherein the buffer portion has a buffer portion inflection point which is recessed, at a surface facing the reinforcing member inflection point.

7. The battery case structure according to claim 4, wherein the buffer portion and the reinforcing member are adhered to and integrated with each other by an adhesive material.

8. The battery case structure according to claim 7, wherein
the adhesive material includes a plurality of adhesive members, and
the adhesive members extend in a direction that intersects an arrangement direction connecting the first buffer top surface and the second buffer top surface to each other, and are arranged along the arrangement direction, in the reinforcing member.

9. The battery case structure according to claim 1, further comprising the road surface interference panel.
